(19) United States
(12) Patent Application Publication
(10) Pub. No.: US 2019/0336986 A1
(43) Pub. Date: Nov. 7, 2019

(54) SPRAYER WITH A SIX-HOLE SPRAY PATTERN

(71) Applicant: Bryan Tapocik, Highland, CA (US)

(72) Inventor: Bryan Tapocik, Highland, CA (US)

(21) Appl. No.: 15/969,388

(22) Filed: May 2, 2018

(51) Int. Cl. B05B 1/14; B05B 1/18; B05B 11/00

(52) U.S. Cl. CPC B05B 1/14; B05B 11/30; B05B 1/185

(57) ABSTRACT

A spray bottle specifically designed for allowing high viscous liquids and gels to be sprayed. The uniqueness involves the nozzle having six holes with a unique spray pattern wherein there is a central hole and five spaced apart perimeter holes. Each perimeter hole is spaced apart from an adjacent perimeter hole by the same distance. Separately, the distance between each respective perimeter hole and the central holes is also the same. The distances between adjacent perimeter holes and the distance from each perimeter hole to the central hole may be the same or may be different.

### BACKGROUND OF THE INVENTION

### Field of the Invention

The field of the invention relates to spray bottles. Specifically, the present invention relates to spray bottles that are used to spray gels or liquids that have high viscosity.

### 2. Description of the Prior Art

The following six patents are the closest prior art known to the inventor:

1. U.S. Pat. No. 6,158,674 issued to Ronald O. Humphreys on Dec. 12, 2000 for “Liquid Dispenser With Multiple Nozzles”.

2. U.S. Pat. No. 7,481,382 issued to Stefan Christ on Jan. 27, 2009 for “Outlet Hood For Device For Spraying A Highly Viscous Liquid”.

3. U.S. Pat. No. 7,748,647 issued to Bernard Clerget et al. on Jul. 6, 2010 for “Spraying Device And Use Of This Device”.

4. U.S. Pat. No. 9,463,476 issued to Juergen Greiner-Perth et al. on Oct. 11, 2016 for “Dispenser For Dispensing Liquids”.

5. German Patent No. DE29900634U1 issued to Werner & Mertz on Jan. 30, 1997 for “Spraying Employment for a Bottle”.

6. Chinese Patent No. CN103550804A issued to Song Zhengquan on Feb. 5, 2014 for “Medical Sterilization Spray Bottle”.

None of the prior art discloses an apparatus specifically designed for spraying high viscous liquids or gel-based substances.

### SUMMARY OF THE INVENTION

The present invention is a spray bottle specifically designed for allowing high viscous liquids and gels to be sprayed. This improved spray bottle provides a six-hole sprayer that allows the spraying of both gels and high viscous liquids. Further, this improved spray bottle provides a central chamber that stores a liquid, and a pump having an actuator at a proximal end and a straw with an opening at a distal end to access the central chamber. The uniqueness involves the nozzle having six holes with a unique spray pattern wherein there is a central hole and five spaced apart perimeter holes. Each perimeter hole is spaced apart from an adjacent perimeter hole by the same distance. Separately, the distance between each respective perimeter hole and the central holes is also the same. The distances between adjacent perimeter holes and the distance from each perimeter hole to the central hole may be the same or may be different. This unique spray pattern combined with the size of the holes enables high viscous and gel-type substances to be sprayed which cannot be sprayed out with a single hole sprayer.

The present invention is an improved spray bottle specifically designed for allowing high viscous liquids and gels to be sprayed. Numerous spray bottles allow for the spraying of low viscous liquids to be discharged in a mist or stream with the depressing of a pump. However, high viscous liquids or gels cannot easily be sprayed by conventional sprayers.

Through extensive research and trial and error of the number of holes, the size of the holes and the spacing between the holes; the present inventor has discovered a pattern and size of holes that permit the spraying of both high viscous liquids and gels.

It is an object of the present invention to provide a sprayer with a six-hole spray pattern that allows the spraying of both gels and high viscous liquids.

It is a further object of the present invention to provide a central chamber that stores a liquid, and a pump including a straw or longitudinal hollow tube with an actuator at a proximal end of the longitudinal hollow tube and an open distal end to gain access to the central chamber. The contents in the chamber is sprayed out of the six holes through the actuator sucking the contents into the longitudinal hollow tube and causing the contents to be ejected or sprayed through the unique sprayer with a six-hole spray pattern.

It is also an object of the present invention to provide a spray bottle that has specifically six holes with a specific surface area for each of the holes.

Further novel features and other objects of the present invention will become apparent from the following detailed description and discussion.

### BRIEF DESCRIPTION OF THE DRAWINGS

Referring particularly to the drawings for the purpose of illustration only and not limitation, there is illustrated:

FIG. 1 is a front perspective view of the present invention sprayer with a six-hole spray pattern with the pump sprayer assembly affixed on top of the liquid container and a removable transparent cap placed over the pump sprayer, the spray nozzle removed to show the opening in the actuator where the spray nozzle is located;

FIG. 2 is an exploded view of the present invention sprayer with a six-hole spray pattern illustrating the pump sprayer assembly removed from the liquid container and the removable cap resting beside the pump sprayer assembly;

FIG. 3 is a close up view of the pump sprayer assembly illustrating the six holes that extend away from one of the pump sprayer's vertical walls and located just below the actuator;

FIG. 4 is a close-up separated view of the top portion of the pump sprayer assembly with the actuator removed and the actuator positioned adjacent to the pump sprayer assembly with the actuator's top surface facing downward;

FIG. 5A is a view of the pump sprayer assembly in the expanded condition with the actuator in the resting position prior to being depressed;

FIG. 5B is a view of the pump sprayer assembly in the compressed condition after the actuator has been depressed; and

FIG. 6 is a schematic of the nozzle of the sprayer with a six-hole spray pattern illustrating the distance between the holes.

### DETAILED DESCRIPTION OF THE PREFERRED EMBODIMENTS

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention.

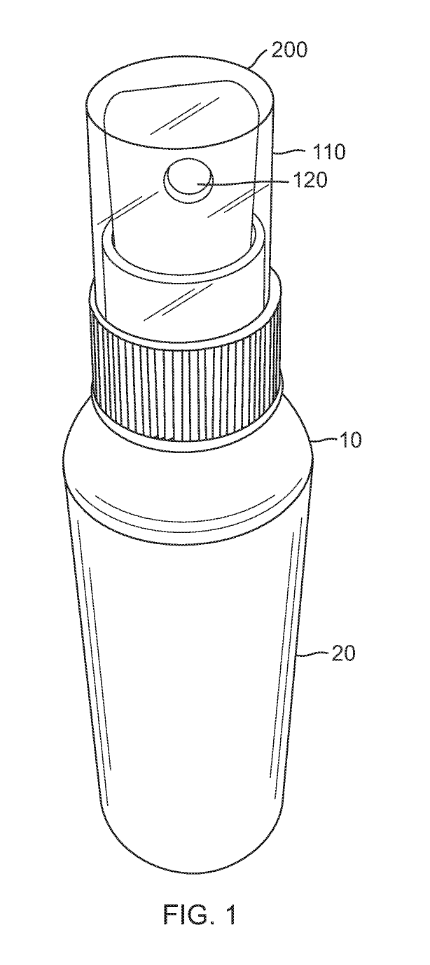

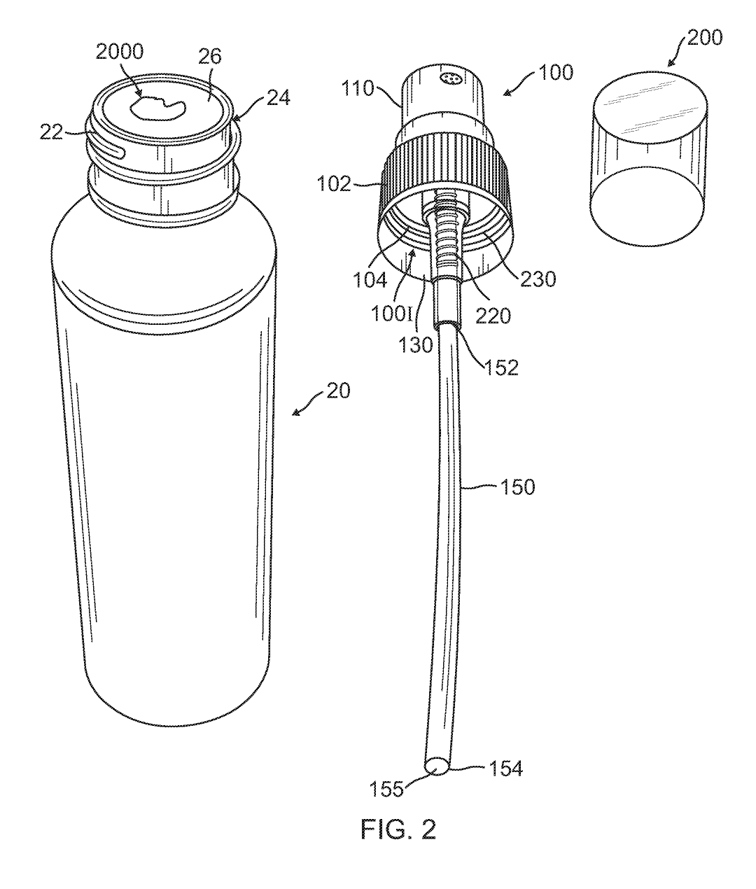

Referring to FIG. 1, there is illustrated the present invention six-hole sprayer 10 completely assembled with a liquid container 20 located on the lower portion of the invention. Directly above the liquid container 20 is the pump sprayer assembly 100 (see FIG. 2) with sprayer cap 200 located above pump sprayer assembly 100 and above the container 20.

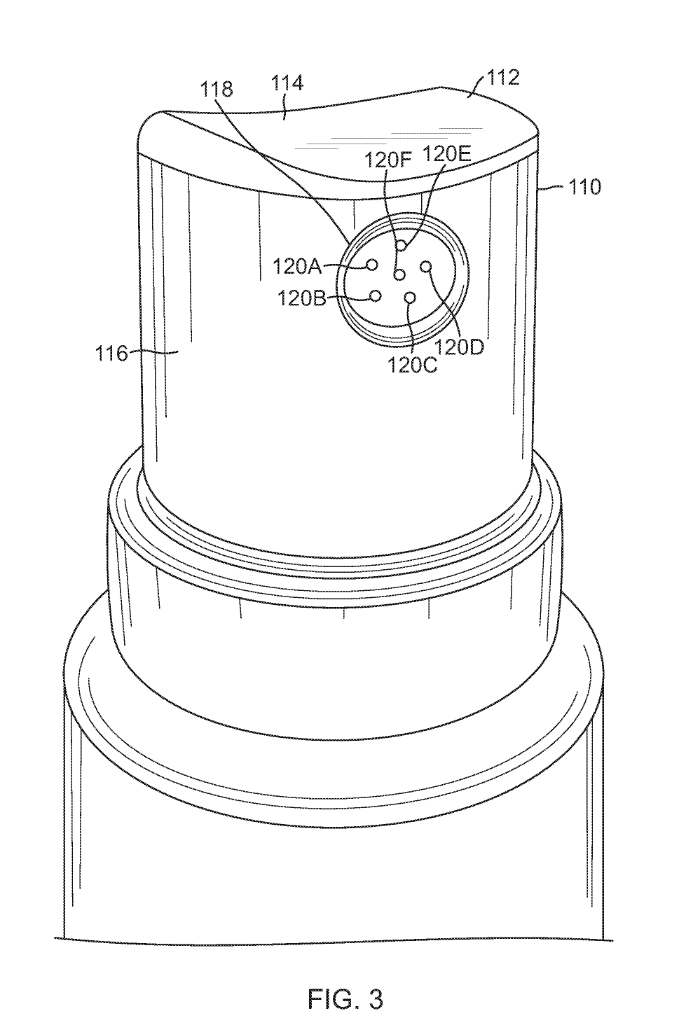

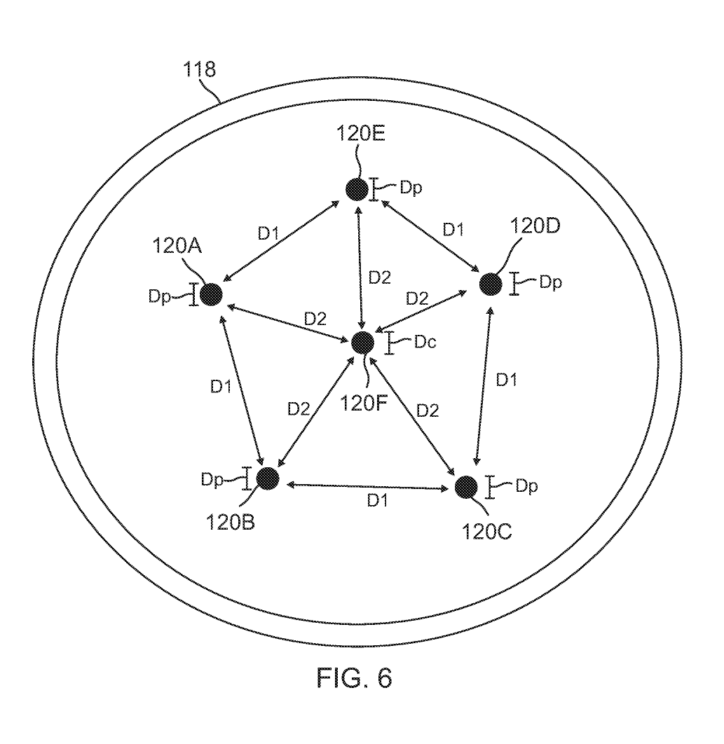

Referring to FIG. 3, pump sprayer assembly 100 has a removable actuator 110 having a predominantly flat actuator perimeter top surface 112 with a central top concave portion 114 shaped to accept a user's finger or thumb. Removable actuator 110 extends from flat actuator perimeter top surface 112 downward to a first actuator vertical circumferential wall 116. As illustrated in FIG. 3, first actuator vertical circumferential wall 116 extends inwardly to an interior vertical actuator wall or nozzle 118. As illustrated in FIGS. 3 and 6, interior vertical actuator wall or nozzle 118 includes six hole openings (120A, 120B, 120C, 120D, 120E, and 120F) through which the substance 2000 (see FIG. 2) in the container 20 passes through and exits the present invention six-hole sprayer 10 when removable actuator 110 is depressed by a user.

Referring to FIG. 2, pump sprayer assembly 100 is located above liquid container 20. Pump sprayer assembly 100 is removably affixed to liquid container 20 by liquid container threads 22 on its nozzle 24 that mate with pump sprayer assembly threads 230 on the interior surface 130 of cap 102 of pump sprayer assembly 100. These threads may be either male or female interlock threads on either the liquid container nozzle 24 or pump sprayer assembly 100. Liquid container 20 has an opening 26 that straw or longitudinal hollow tube 150 extends into to extract substance 2000. Straw and longitudinal hollow tube refer to the same part 150.

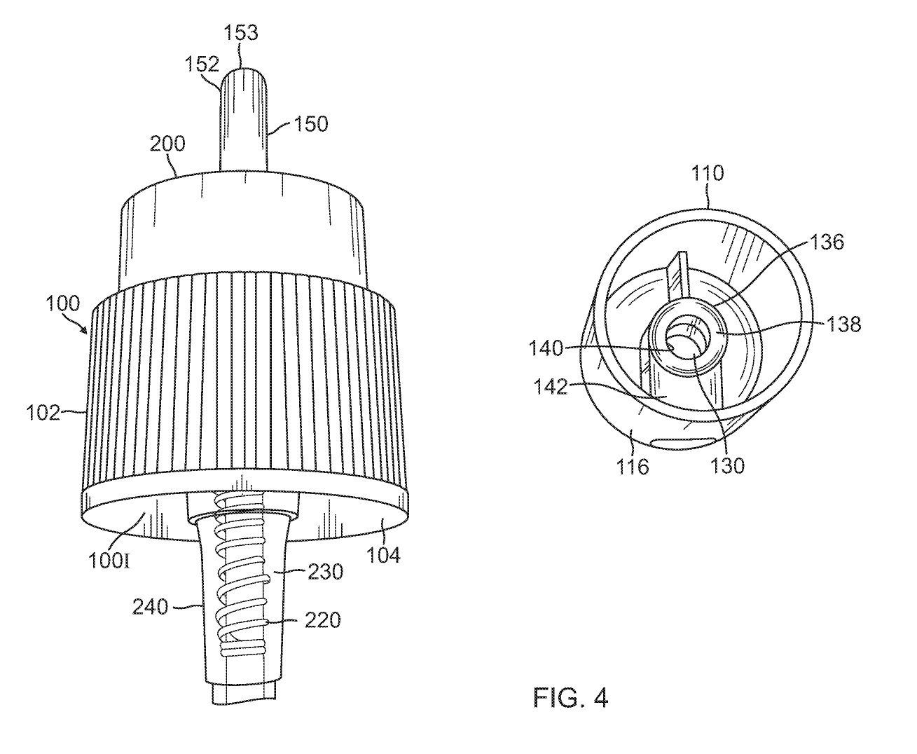

Referring to FIGS. 2 and 4, pump sprayer assembly 100 has a straw 150 that extends from a straw proximal end 152 to a straw distal end 154 having a distal opening 155. In the fully assembled condition as illustrated in FIG. 1, straw proximal end 152 has a straw upper opening 153 retained within an actuator interior vertical circumferential wall 136. Actuator interior vertical circumferential wall 136 extends upwardly from a vertical chamber lower elevation or bottom elevation 138 to a vertical chamber upper elevation 140. At vertical chamber upper elevation 140, actuator interior circumferential vertical wall 136 transitions to an actuator interior circumferential horizontal wall 142. Collectively, actuator interior circumferential vertical wall 136 and interior circumferential horizontal wall 142 form an integrally connected “L”-shaped valve that encloses actuator interior chamber 130 and allows gel or viscous liquid 2000 to pass from opening 155 in distal end 154 of straw 150 through straw 150 and up through straw proximal end 152 through opening 153 and to hole openings 120A, 120B, 120C, 120D, 120E, and 120F. Hole opening 120F is centrally located on actuator opening 120 (see FIG. 1) of pump sprayer assembly 100 and hole openings 120A, 120B, 120C, 120D, and 120E are positioned equidistant around central hole opening 120F. The shape of hole openings 120A, 120B, 120C, 120D, 120E, and 120F is generally circular. However, it is within the spirit and scope of this invention for these holes to be of shapes other than circular such as rectangular, trapezoidal, octagonal, or other commonly known polygons.

Referring to FIGS. 2 and 4, pump sprayer assembly 100 has a pump circumferential exterior wall 102 and a pump circumferential interior wall 104 that surrounds an interior chamber 100I. Centrally located within interior chamber 100I is the fluid pump 200. Fluid pump 200 consists of a piston 230 and a spring 220 that are housed inside of a cylinder 240. The present invention is not the invention of a fluid pump, but rather the improvement over the prior art fluid pump by extensive research and design to allow a gel or high viscous liquid to be sprayed from a pump. Gels and high viscous liquids through the present invention design which includes the size, location, and number of these holes, allows gels and high viscous liquids to be efficiently sprayed. The details of the size, location, and number of these holes will be discussed below.

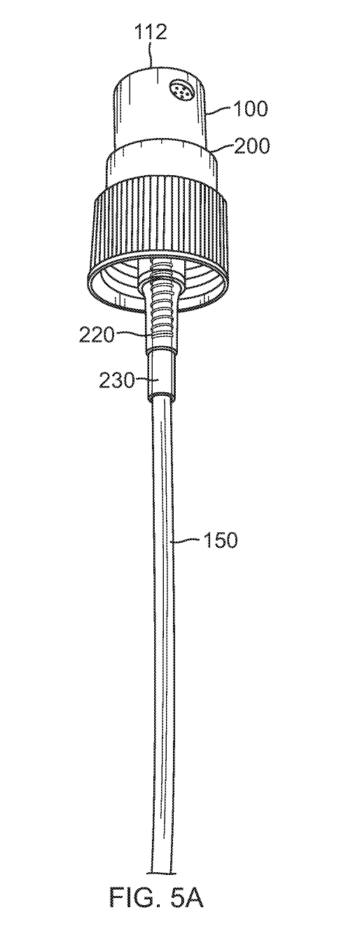

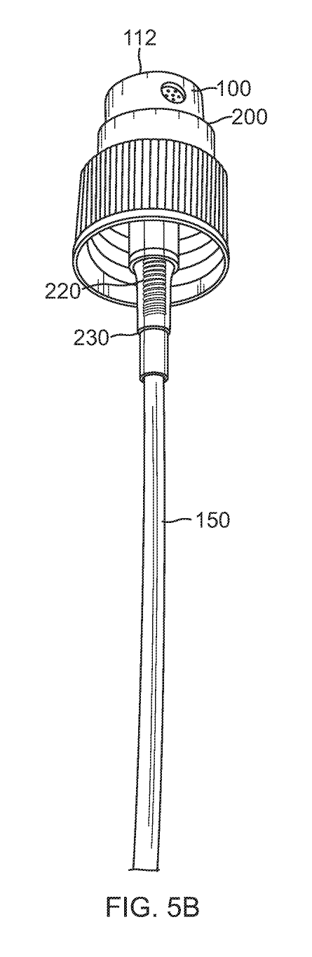

Referring to FIGS. 5A (actuator released) and 5B (actuator depressed), the operation of fluid pump 200 is performed by a user depressing interior surface 114 surrounded by flat actuator top surface 112 of actuator 110. When actuator 110 is depressed, it forces piston 200 (FIG. 4) to compress spring 220 which reduces the amount of volume in cylinder 230. This reduction of volume in cylinder 230 forces the liquid or gel within the upper portion of straw 150 to be forced upward through interior chamber 130, through opening 153 and out of hole openings 120A, 120B, 120C, 120D, 120E, and 120F. When actuator 110 is released, piston 200 (FIG. 5B) moves upward from the force of spring 220 moving from a compressed condition to its initial or starting position. The movement of piston 200 downward creates a suction force that pulls gel or high viscous liquid 2000 into opening 155 of straw distal end 154, through straw 150 to straw proximal end 152 and through straw opening 153.

Referring to FIG. 6, there is illustrated a schematic of the nozzle 118 of the present invention. The improved nozzle includes one centrally located hole opening 120F and five outer hole openings 120A, 120B, 120C, 120D, and 120E around the one centrally located hole opening 120F. Each of the openings is the same size. Each opening for each of the five outer hole openings is positioned a distance D2 equidistant away from the one centrally located hole opening 120F. Each outer hole opening is positioned an equal distance D1 apart from each adjacent outer hole opening. With this unique spray opening pattern, spray opening hole size, and relative distance between holes as described, nozzle has six hole openings that allow the passage of high viscous liquids and gels to pass through and form a spray when the removable actuator is depressed. The shape of each of the six hole openings is preferably circular.

Through numerous research and design efforts, it was discovered that the number of hole openings should be six. If the hole openings are increased in number, the present invention gel and high viscous sprayer will not spray efficiently or will not spray at all. Further, the distance D1 between each of the outer holes 120A, 120B, 120C, 120D, and 120E must be approximately equal and this distance is 0.54 mm to 0.60 mm. Similarly, the distance D2 from center hole 120F to each of the outer holes must be approximately equidistant with this distance from center hole 120F to each of the outer holes being 0.54 mm to 0.60 mm. Lastly, the surface area of each of the hole openings must be equal. This allows equal pressure distribution of the internal pressure created during the depressing of actuator 110. The surface area opening for each of the holes is equal to approximately 0.196 mm² based on the holes having a diameter of 0.5 millimeters (mm) illustrated in FIG. 6 as center hole 120F having a diameter Dc of 0.5 mm and outer holes 120A, 120B, 120C, 120D, and 120E having a diameter Dp of 0.5 mm.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

What is claimed is:

1. A hand pump sprayer adapted for use with a liquid container, the hand pump sprayer c comprising:
a. a piston assembly including a pump sprayer, a fluid pump, a sprayer cap, a removable liquid actuator and a nozzle;
b. said pump sprayer assembly partially located above said liquid container with said pump sprayer assembly having a removable actuator with a top surface including a flat circumference and a concave interior top;
c. said removable actuator extending from said top surface downward to a first actuator vertical circumferential wall and said first actuator vertical circumferential wall extending inwardly to the nozzle;
d. said nozzle having six hole openings;
e. said pump sprayer assembly further including a straw that extends from a straw distal end with a distal opening within the container and extending to a straw proximal end with said straw proximal end having a straw upper opening that is retained within an actuator interior vertical circumferential wall with said actuator interior vertical circumferential wall extending upwardly from a vertical chamber lower elevation to a vertical chamber upper elevation;
f. said actuator interior circumferential vertical wall transitions to an actuator interior circumferential horizontal wall at said vertical chamber upper elevation;
g. said actuator interior circumferential vertical wall and said interior circumferential horizontal wall are integrally connected to form an integrally connected “L”-shaped valve that encloses an actuator interior chamber;
h. said “L”-shaped valve allows liquid to pass from said opening in said distal end of said straw, through said straw, to said straw proximal end to said six hole openings;
i. the six hole openings have one centrally located hole opening and five outer hole openings positioned around the one centrally located hole opening;
j. the five outer hole openings have equally sized openings and an equally sized surface area;
k. the one centrally located hole has a surface area for the hole opening equal to the surface area of each of the hole openings for each of the five outer hole openings;
l. each of the five outer hole openings are positioned equidistant away from the one centrally located hole opening; and
m. each outer hole opening is positioned an equal distance from each adjacent outer hole opening; and
n. the central opening having a diameter of 0.5 mm and each of the outer five hole openings having a diameter of 0.5 mm;
o. whereby, the six hole openings allow the passage of high viscous liquids and gels to pass through and form a spray when the removable actuator is depressed.

2. The hand pump sprayer in accordance with claim 1, further comprising: the surface area of each of the outer holes is 0.196 mm² and the surface area of the central opening is 0.196 mm².

3. The hand pump sprayer in accordance with claim 1, further comprising:
a. the distance between the central opening and each of the five outer hole openings is between 0.54 mm and 0.60 mm; and
b. the distance between each of the five outer hole opening between adjacent outer hole openings is between 0.54 mm and 0.60 mm.

4. The hand pump sprayer in accordance with claim 1, further comprising: the fluid pump consists of a piston and a spring that are housed inside of a cylinder.

5. The hand pump sprayer in accordance with claim 1, further comprising: said piston is located above said spring within said pump sprayer assembly.

6. The hand pump sprayer in accordance with claim 1, further comprising: the removable actuator is located above said pump sprayer assembly.

7. The hand pump sprayer in accordance with claim 1, further comprising: the shape of each of the six hole openings is generally circular.

8. In an existing hand pump sprayer having a liquid container, a pump sprayer, a fluid pump, a sprayer cap, a removable actuator, and an improved nozzle, the improved nozzle comprising:
a. said improved nozzle having six hole openings with one centrally located hole opening and five outer hole openings positioned around the one centrally located hole opening;
b. each of the five outer hole openings having equally sized hole openings with an equally sized surface area;
c. the one centrally located hole having a surface area for the hole opening equal to the surface area of each of the respective hole openings for each of the five outer hole openings;
d. each of the five outer hole openings positioned an equal distance away from the one centrally located hole opening;
e. each outer hole opening positioned an equal distance apart from each adjacent outer hole opening;
f. the shape of each of the five outer hole openings is circular and the shape of the one centrally located hole is circular;
g. the diameter of the central opening is 0.5 mm and the diameter of each of the outer five hole openings is 0.5 mm;
h. the distance between the central opening and each of the five outer hole openings is between 0.54 mm and 0.60 mm; and
i. the distance between each of the five outer hole openings between adjacent outer hole openings is between 0.54 mm and 0.60 mm;
k. wherein, the improved nozzle has six hole openings that allow the passage of high viscous liquids and gels to pass through and form a spray when the removable actuator is depressed. 9, The improved nozzle in accordance with claim 8, further comprising: the surface area of each of the five outer hole openings is 0.196 mm² and the surface area of the one centrally located hole is 0.196 mm².

10. In an existing hand pump sprayer having a liquid container, a pump sprayer, a fluid pump, a sprayer cap, a removable actuator, and a nozzle, the improvement comprising:
a. an improved nozzle having six hole openings with one centrally located hole opening and five outer hole openings positioned around the one centrally located hole opening;
b. the improved nozzle having each of the five outer hole openings having equally sized openings with equally sized surface openings;
c. the improved nozzle having the one centrally located hole having a surface area for the hole opening equal to the surface area of each of the openings for each of the five outer hole openings;
d. the improved nozzle having each of the five outer hole openings positioned a distance equidistant away from the one centrally located hole opening; and
e. the improved nozzle having each outer hole opening positioned an equal distance from each adjacent outer hole opening;
f. wherein, the improved nozzle has six hole openings that allow the passage of high viscous liquids and gels to pass through and form a spray when the removable actuator is depressed.

11. The improved nozzle in accordance with claim 10, further comprising: the shape of each of the six hole openings are generally circular.

12. The hand pump sprayer in accordance with claim 11, further comprising:
a. the diameter of the central opening is 0.5 mm; and
b. the diameter of each of the outer five hole openings is 0.5 mm.

13. The improved nozzle in accordance with claim 12, further comprising: the surface area of each of the five outer hole openings is 0.196 mm² and the surface area of the one centrally located hole is 0.196 mm².

14. The hand pump sprayer in accordance with claim 10, further comprising:
a. the distance between the central opening and each of the five outer hole openings is between 0.54 mm and 0.60 mm; and
b. the distance between each of the five outer hole opening between adjacent outer hole openings is between 0.54 mm and 0.60 mm.
